(19) United States
(12) Patent Application Publication
(10) Pub. No.: US 2023/0368057 A1
(43) Pub. Date: Nov. 16, 2023

(54) Polarized Particles in a Spin-Transparent Storage Ring as a Quantum Computer

(71) Applicant: JEFFERSON SCIENCE ASSOCIATES, LLC, Newport News, VA (US)

(72) Inventors: Riad SULEIMAN, Yorktown, VA (US); Vasiliy MOROZOV, Lenoir City, TN (US)

(21) Appl. No.: 18/112,232

(22) Filed: Feb. 21, 2023

Related U.S. Application Data
(60) Provisional application No. 63/318,540, filed on Mar. 10, 2022.

(51) Int. Cl. G06N 10/20; G06N 10/40

(52) U.S. Cl. CPC G06N 10/20; G06N 10/40

(57) ABSTRACT

A system and a method for a scalable quantum computing technology implemented using polarized electrons, ions, or paramagnetic neutral atoms in a spin-transparent storage ring that exhibits long quantum coherence times of at least three hours. The method relies on the spin degree of freedom of polarized particles as the physical quantum bit.

This application claims the priority of Provisional U.S. Patent Application Ser. No. 63/318,540 filed Mar. 10, 2022.

The United States Government may have certain rights to this invention under Management and Operating Contract No. DE-AC05-06OR23177 from the Department of Energy.

### BACKGROUND OF THE INVENTION

Quantum computers have the potential to make significant impacts in the fields of cryptography, machine learning, pharmacology, and finance due to their ability to run critical algorithms with significantly increased computational efficiency compared to classical computers. A quantum computer leverages the essential features of superposition, entanglement, and interferences present in the governing laws of quantum mechanics to access this increased computational complexity. These key features are tenuously present in most physical systems, making a capable quantum computer challenging to implement in practice. Researchers are exploring several promising technological platforms, but none of them so far succeeded in realizing a full-scale universal quantum computer.

Many technologies are being developed for quantum computation spanning much of modern physics such as atomic physics, quantum optics, nuclear magnetic resonance spectroscopy, superconducting electronics, and quantum-dot physics. The various quantum technologies being explored include superconducting-based quantum computing, trapped-ion technologies and photonics technologies. However, it remains unclear which technology will ultimately prove to be the most successful dealing with the myriad challenges facing quantum computing.

The criteria to realize a quantum computer generally include:
a. A scalable physical system with well characterized quantum bits (qubits);
b. The ability to initialize the state of the qubits to a fiducial state;
c. Capability to perform a “universal” set of quantum one- and two-qubit gates (operations) with high fidelity;
d. A qubit-specific measurement capability; and
e. Long relevant coherence times of the qubit that are long compared to the relevant gate time in order to be able to perform sufficient operations to comprise an algorithm.

The several quantum computing platforms currently being explored satisfy all of these criteria, each offering its relative advantages. For example, trapped-ion systems excel in state-preparation, measurement, and gate fidelity, while superconducting qubits offer fast gate times and manufacturability.

Two of the greatest challenges involved with constructing quantum computers are preserving quantum coherence and implementing scalability. Loss of coherence in the computational qubit in a quantum system comes from its interactions with external world and fluctuations of control parameters in quantum operations. Trapped ions have demonstrated qubit coherence times of greater than 1 hour while superconducting qubits typically perform at the 100 μs level, with recent results exceeding 1 ms. Challenges posed by the coherence time are directly coupled to the gate time, the time it takes to perform a single operation on the qubit. Ultimately, the ratio of the coherence time to the gate time determines how powerful the quantum computer is. Computational power of the quantum computer increases exponentially with the number of qubits. Scalability is the measure of a quantum system's ability to increase the number of qubits without an exponential increase in cost of resources (such as time, space or energy). Every time a qubit is added, the computational power doubles in size.

Accordingly, there is a need for providing a quantum computer with improved quantum coherence time, preferably of several hours, and with improved scalability, supporting algorithms with deep complexity requiring many quantum operations while simultaneously providing a large number of qubits.

### BRIEF SUMMARY OF THE INVENTION

The invention is a quantum computing platform that includes a beam of polarized particles stored in a spin-transparent storage ring as a scalable system of qubits in which the qubits have a long quantum coherence time, i.e. the entangled spin quantum states of the stored particles can be “frozen” in the spin-transparent storage ring for a long time of at least 3 hours. The stored particles suited to this quantum computing platform can be polarized electrons, ions (e.g., H⁻, D⁻, ³He⁺, ^{6,7}Li⁺², ⁹Be⁺, ¹³⁸Ba⁺, ¹⁷¹Yb⁺) or paramagnetic neutral atoms (e.g., H⁰, D⁰, ³He⁰, ^{6,7}Li⁰).

Polarized electrons, ions, or paramagnetic neutral atoms in spin-transparent storage rings are compatible with all of the above criteria to realize a quantum computer. Moreover, the ability to store up to 100,000 polarized bunches where each bunch constitutes a qubit, with coherence times of at least 3 hours, makes the storage ring platform very appealing. These two exceptional qualities mean storage rings could provide a scalable way to implement algorithms with deep complexity requiring many quantum operations while simultaneously providing a large number of qubits.

The quantum computing platform uses the spin quantum properties only and does not rely on the quantum effects of the particle motion and inter-bunch interaction. The temperature of the platform apparatus can be up to room temperature. Furthermore, particle cooling is not required; the effective temperature of the particles can be anywhere in the range of 10 K to 10,000 K.

### BRIEF DESCRIPTION OF THE SEVERAL VIEWS OF THE DRAWING(S)

Reference is made herein to the accompanying drawings, which are not necessarily drawn to scale, and wherein:

FIG. 1 depicts a plan view of a spin-transparent storage ring in a figure-8 configuration.

FIG. 2 depicts a block diagram of a quantum computer using polarized electrons in accordance with first embodiment of the present invention.

FIG. 3 depicts a block diagram of a quantum computer using polarized ions and neutral atoms in accordance with second embodiment of the present invention.

FIG. 4 depicts a block diagram of a quantum computer using polarized ions and neutral atoms in accordance with third embodiment of the present invention.

### DETAILED DESCRIPTION OF THE INVENTION

Table 1 compares spin-transparent storage ring capabilities with the state-of-the-art of several mature quantum computing platforms. At the present time, the number of superconducting qubits is reported to be 127 and the number of photonic qubits is reported to be 216.

TABLE 1
Comparison between spin-transparent storage ring capabilities and
the state-of-the-art of several mature quantum computing platforms.

| | Storage Ring | | Superconducting | | Trapped | | Photon- |
|---|---|---|---|---|---|---|---|
| | (expected) | | Qubits | | Ions | | ics |
| Number of Qubits | 1-100,000 | | 127 | | 32 | | 216 |
| Coherence Time | >3 | hours | 1 | ms | 5500 | s | — |
| Measurement | >0.99 | | 0.999 | | 0.9993 | | 0.98 |
| Fidelity | | | | | | | |
| Gate (Operation) | ~10 | ns | 4 | ns | 1.6 | μs | — |

| Time | | | | |
|---|---|---|---|---|
| One-Qubit Gate | >0.99 | 0.9992 | 0.999999 | 0.986 |
| Fidelity | | | | |
| Two-Qubit Gate | >0.99 | 0.995 | 0.997 | 0.93 |
| Fidelity | | | | |

The spin-transparent storage ring described herein can capture and store almost any polarized particle. The technology can be applied to electrons as well as to any other charged and paramagnetic neutral particles. For example, H⁻ or D⁰ is also a simple particle that could be trapped in a storage ring. In addition to the electron spin degree of freedom, it also has a nuclear (proton or proton and neutron) spin degree of freedom. The total spin of a composed particle may also be treated as a single qubit. Moreover, it can be controlled by electromagnetic fields including lasers (photons), allowing for spin manipulation and measurement schemes.

A spin-transparent ring offers the capability of capturing and storing an arbitrary number of spin-entangled particles while maintaining their spin coherence. A spin-transparent ring is designed to make the spin dynamics degenerate, i.e., the spin transformation in one turn around the ring is an identity transformation. The spin-transparency feature of such a ring is independent of its exact geometry as long as the ring is flat and the net beam bending angle is zero.

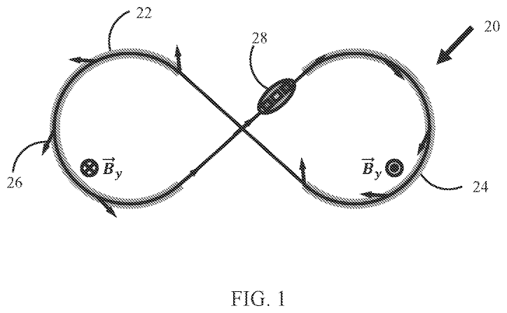

With respect to FIG. 1, the most natural spin-transparent topology is a figure-8 ring 20 configuration. The spin-transparent ring 20 includes a first arc 22 with the magnetic field direction into the page and a second arc 24 with the magnetic field direction out of the page. Spin direction of the particles at various points of the ring is denoted by the arrows 26. A three-dimensional (3D) spin corrector 28 is included in the second arc 24 of the ring.

A conventional polarized ring has a distinct spin direction \vec{n}₀ that the spins of all particles precess about. The rate of this precession is called a spin tune v. In terms of two-component spinors Ψ, the spin transformation in one turn around a ring is described by a 2×2 matrix

$$M = exp \{ - \frac{i}{2} ( {\vec{n}}_{0} \cdot \vec{σ} ) ϕ \} ,$$

where \vec{σ} is a vector of the three 2>2 Pauli matrices and Φ is the spin rotation angle. In a conventional ring, \vec{n}₀ is in the vertical direction. All the spins precess about the vertical magnetic fields of the bending dipoles. Since the spin precesses about magnetic field Gγ times faster than momentum, where G is the particle's anomalous gyro-magnetic ratio and γ is the relativistic factor, the spin makes Gγ revolutions about the vertical direction in one particle turn around a conventional circular ring, i.e., Φ=GγΦdθ=πGγ v=Gγ.

The spin components perpendicular to \vec{n}₀ decohere in the conventional polarized ring. The main cause of this decoherence is the spread in v due to the spread in the particle energies Δγ, which is always present in a particle beam: Δv=GΔγ. For practical beam parameters, full polarization decoherence occurs in several thousand turns.

The spin-transparent ring configuration shown in FIG. 1 offers a universal solution to this decoherence problem that this invention relies on. Clearly, since the bending angle Φdθ in one turn is zero, the spin rotation in one turn is identically zero as well, independent of the particle energy, i.e. Φ=GγΦdθ=0. For a particle of any given energy, the spin rotation in one arc 22 is completely compensated by an equal but opposite rotation in the other arc 24. This mechanism is also known as the spin-echo effect.

For a spin-transparent storage ring, the single-turn spin transformation matrix as described hereinabove becomes an identity matrix:

$$M = exp \{ - \frac{i}{2} ( {\vec{n}}_{0} \cdot \vec{σ} \} {\vert}_{ϕ = 0} = I .$$

Any initial spin orientation transforms back into itself in one turn around the ring, i.e. there is no change in the spin from turn to turn regardless of its initial state. The spin state is frozen.

What is described above is, of course, an ideal situation. There are realistic effects causing deviation from this ideal picture. Firstly, any real ring has imperfections distorting its closed orbit in relation to the ideal design orbit. Secondly, particles undergo betatron and synchrotron oscillations about the closed orbit.

The second effect due to particle oscillations is of higher order than the first effect due to ring errors and is usually dominated by it. In the closed orbit distortion effect, the vertical distortion level is of the main concern because it leads to a net spin rotation in one turn around the ring. Vertical orbit distortion is caused primarily by vertical quadrupole magnet misalignments and dipole magnet roll. The sensitivity of the spin to these errors can be readily evaluated using the spin response function formalism for spin-transparent rings. This effect has been studied within the context of GeV rings. It has been suggested and demonstrated in simulations that the imperfection spin effect can be measured and suppressed by a local 3D spin corrector 28 consisting of weak magnets as illustrated in FIG. 1. The application of compensation measures combined with error control provides the necessary coherence time.

The strengths of the spin-transparent storage ring technology are the long coherence times that it offers, as well as the large number of stored bunches each containing as many particles as needed, from 1 particle to 10¹⁰ particles. Other avenues for scaling beyond the maximum number of stored bunches is the use of multiple rings, for example.

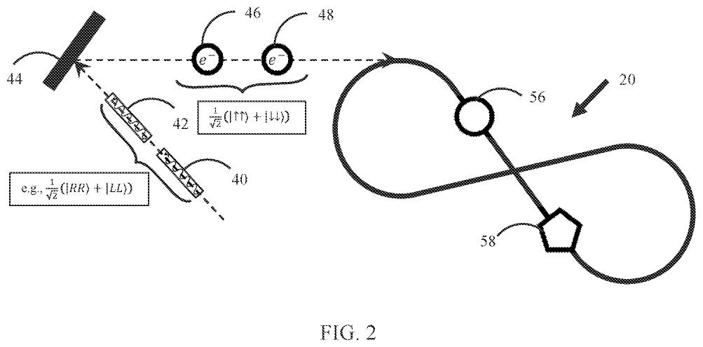

Referring to FIG. 2, there is shown a first embodiment of the invention where the particle used is an electron. The entangled circularly polarized photon bunches 40 and 42 are impinging on a polarized electron photo-cathode 44. The spin-entangled electron bunches 46 and 48 are generated and injected into the spin-transparent storage ring 20. One-qubit gates are performed using a one-qubit gate unit 56 (e.g., sequence of pulsed magnets). The final states of the qubits after completing the quantum computations are measured using a measurement unit 58 (e.g., Mott polarimeter).

A quantum computer according to the present invention relies on a polarized electron beam in a spin-transparent storage ring as a scalable multi-qubit system. A polarized bunch of spin-aligned electrons displays the quantum-mechanical nature of the spin degree of freedom and constitutes a macroscopic quantum state that can be deterministically manipulated by electromagnetic fields. A single qubit can be implemented by a single electron bunch. All electrons in the bunch are generated in the same quantum spin state, which can be a superposition of the spin eigenstates α|↑ [symbol] +b|↓ [symbol] . Such a bunch is generated from a polarized photo-cathode 44 using a circularly polarized laser light. An appropriately prepared laser pulse where all photons are in the same quantum superposition state of right-handed and left-handed circular polarizations produces a polarized electron bunch with the required initial quantum superposition of longitudinal spin states.

The spin state of the electron bunch can optionally be further manipulated. The bunch is then injected into a spin-transparent storage ring that exhibits long quantum coherence time of at least 3 hours. As an element of the ring, a one-qubit gate unit 56 can perform arbitrary polarization rotations. The rotations of the bunch polarization can be deterministically done using a magnetic field with fidelity of better than 0.99.

As an example, with reference to FIG. 2, two spin-entangled polarized electron bunches can be generated. Polarized electron bunches 46 and 48 are produced by a properly timed sequence of polarized laser pulses 40 and 42. However, to achieve spin entanglement of the electron bunches, their generating photon pulses must be polarization-entangled themselves. FIG. 2 illustrates a sequence of two spatially-separated laser pulses 40 and 42. These laser pulses are in the initial spin-entangled quantum state of their right-handed (R) and left-handed (L) circular polarizations, such as Ψᵢ=(|RR [symbol] +|LL [symbol] )/2. The two laser pulses are used to produce a sequence of two spatially-separated electron bunches 46 and 48. These electron bunches are in the spin-entangled quantum state of positive- and negative-longitudinal polarizations, such as Ψᵢ=(|↑↑ [symbol] +|↓↓ [symbol] )/2. The entanglement of electron bunches is generated by transfer of entanglement from the laser pulses in the process of photoemission from the polarized photo-cathode 44.

In the present invention, the polarization entanglement of the laser pulses 40 and 42 is transformed into the spin entanglement of the electron bunches 46 and 48 in the process of quantum emission from the polarized photo-cathode 44. As illustrated in FIG. 2 for the case of two qubits, the initial spin states of the two corresponding electron bunches A and B is given by |Ψ [symbol] _{AB}=Σ_{i,j}mᵢⱼ|i [symbol] _{A}⊗|j [symbol] _{B} with Det(M)≠0. Implementation of this mechanism requires generation of pulses of polarization-entangled photons and time separation of the individual photons in the identical entangled photon combinations. The generated spin-entangled electrons then belong to different bunches. The spin-entangled electron bunches are then injected into a spin-transparent storage ring with the spin entanglement preserved. The spin-transparency feature of the ring maintains the entangled spin state. The number of electron bunches can be scaled as needed together with the ring design. The measurement of the electron beam polarization states is accomplished using a Mott polarimeter 58. The measurement of the state can be done with fidelity of better than 0.99 limited by the polarimeter statistical and systematic uncertainties.

In the spin-transparent ring, the superposition and entangled electron quantum spin states, |Ψ [symbol] _{AB}, can be manipulated using electromagnetic fields 56. One-qubit gates (operations) can be performed using pulsed electromagnetic fields to deterministically rotate the spin of individual electron bunches.

The quantum state of the electron qubit is measured using a conventional Mott polarimeter. The polarimeter can simultaneously determine both the horizontal and the vertical asymmetries. The horizontal asymmetry is sensitive to the vertical polarization component while the vertical asymmetry will be used to measure the horizontal polarization component. Mott polarimetry based on elastic scattering of transversely polarized electrons from high-Z atomic nuclei is the standard technique for measuring electron beam polarization in the energy range from 20 keV to 5 MeV. As a part of the ring, a Mott polarimeter is used to measure the transverse polarization of the electron bunches, |mᵢⱼ|². A kicker will direct the beam to a gold foil. The horizontal and vertical asymmetries in the detected backscattered electrons will be used to measure both the horizontal and vertical polarizations of the electron bunches. This is a destructive measurement and a new set of qubits can be reinjected into the spin-transparent storage ring.

In addition to electrons, polarized ions such as H⁻, D⁻, ³He⁺, ^{6,7}Li⁺², ⁹Be⁺, ¹³⁸Ba⁺, or or ¹⁷¹Yb⁺ can be used in a spin-transparent storage ring as a scalable multi-qubit system. The spins of the nuclei of these ions couple to the spins of the outer-shell atomic electrons through the hyperfine interaction. Quantum gates are performed by manipulating the hyperfine states of these electrons. The measurement of the quantum state at the end of the computation is carried out by measuring the spin states of these electrons.

Paramagnetic neutral atoms such as H⁰, D⁰, ³He⁰, or ^{6,7}Li⁰ can also be used in a spin-transparent storage ring as a scalable multi-qubit system. These atoms are subject to magnetic-field-gradient forces on their magnetic moments and can be confined in a storage ring. Lasers are used to manipulate and measure the state of the stored atoms.

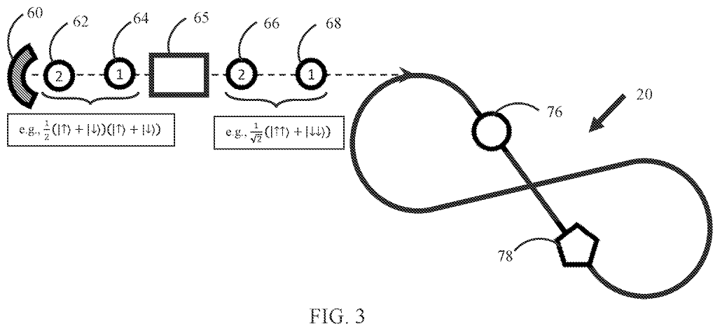

With reference to FIG. 3, a second embodiment of the invention is shown where the qubits 62 and 64 are initially generated un-entangled from a particle source 60. The spin-initialization unit 65 sets the qubits in the necessary spin superposition states using electromagnetic fields or lasers. The same spin-initialization unit 65 also converts un-entangled bunches 62 and 64 into entangled qubits 66 and 68. The entanglement part of the spin-initialization unit, such as a high-Q cavity, interacts with the polarization of the first bunch. Its interaction with the polarization of the second bunch depends on the polarization of the first bunch. As a result, the spin states of the two bunches become entangled. FIG. 3 illustrates the situation wherein such an entanglement is performed before injection of the particles in the spin-transparent storage ring. Such a unit can also be used in the ring to initialize the qubit spin states after injection. One- and two-qubit gates are performed using a unit for applying one- and two-qubit gates 76. The final states of the qubits after completing the quantum computations are measured using a measurement unit 78.

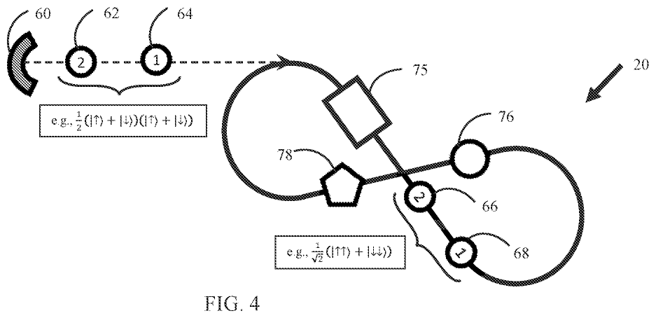

Referring to FIG. 4, a third embodiment is illustrated where single qubits 62 and 64 are implemented by individual bunches from a particle source similar to FIG. 3. The bunches are either produced polarized or polarization is induced by electromagnetic fields or lasers. The initial spin state including superposition and entangled qubit spin states is set before or after injection of the particles in the spin-transparent storage ring using a spin-initialization unit 75. FIG. 4 illustrates the latter case. The entanglement in this embodiment is induced by transferring the spin information from entangled photons to the particles, a process known as remote entanglement. Such a transfer is done by making transitions between the different spin states of the particle. The remote entanglement in this scenario eliminates the need for any inter-bunch interaction.

A quantum computer according to the present invention relies on a polarized ¹⁷¹Yb⁺ beam in a spin-transparent storage ring as a scalable multi-qubit system. Polarized ¹⁷¹Yb⁺ can be prepared in the beam by using optical pumping of ¹⁷¹Yb⁺ atoms into a single hyperfine state, which are then injected into the storage ring. The ¹⁷¹Yb⁺ atomic ion is highly suitable for use as a qubit in a storage ring due to its ease of long-lived hyperfine qubit, which have been demonstrated in radiofrequency Paul traps. The spin of the ¹⁷¹Yb⁺ qubit can be measured using state-dependent resonant fluorescence, where the ¹⁷¹Yb⁺ ion interacts with a laser beam and fluoresces photons when it is in one hyperfine spin state, and does not interact with the laser when it is in the other state. This provides a highly effective and alternative method of measuring the state of the qubit in the storage ring.

The present invention provides a new platform for quantum computing based on polarized particles in a spin-transparent storage ring. Storage rings have three core strengths that rival the capabilities of even the most developed quantum computing platforms: 1) the large number of particles that can be stored in the ring, 2) long coherence times of at least 3 hours, and 3) lack of strict thermal constraints by using the spin quantum properties only and not relying on the quantum effects of the particle motion and inter-bunch interaction. This new platform where the qubit has long coherence time can also be used as a quantum sensor or part of a quantum memory.

This new quantum computing platform has at least the following novel features:
a. Relies on a beam of polarized particles stored in a ring as a scalable system of qubits,
b. Includes a long quantum coherence time — the entangled spin quantum states of the stored particles can be “frozen” in the spin-transparent storage ring for a long time of at least three hours,
c. Temperature of platform apparatus (particle source, storage ring, . . . ) can be up to room temperature—the method is not subject to the thermal time limit hindering the prevalent superconducting-based quantum computing, and
d. Does not rely on cooling the particles—the effective temperature describing the transverse motion of the particles can be anywhere in the range of 10 K to 10,000 K, i.e., not requiring an ion Coulomb crystal.

Although the quantum computing platform has been illustrated in application to polarized electrons, it can also use other polarized particles such as ions (e.g., H⁻, D⁻, ³He⁺, ^{6,7}Li⁺², ⁹Be⁺, ¹³⁸Ba⁺, ¹⁷¹Yb⁺) or paramagnetic neutral atoms (e.g., H⁰, D⁰, ³He⁰, ^{6,7}Li⁰), which offer other advantages to this new quantum computing platform.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. While the invention has been described with respect to preferred embodiments, those skilled in the art will readily appreciate that various changes and/or modifications can be made to the invention without departing from the spirit or scope of the invention as defined by the appended claims.

I claim:

1. A scalable quantum computer, comprising:
a spin-transparent storage ring preserving the quantum coherence time of stored polarized particle bunches by at least 3 hours;
each of said polarized particle bunches serving as a quantum qubit having a spin degree of freedom and that is free of quantum effects of particle motion and inter-bunch interaction;
said spin-transparent storage ring operated at temperatures up to room temperature;
a spin-initialization unit setting the initial spin state of said polarized particle bunches stored in said spin-transparent ring;
a qubit gate unit to perform quantum operations in said spin-transparent ring, said qubit gate unit including a one-qubit gate and a two-qubit gate; and
a measurement unit to determine the final spin state of the stored particle bunches after completion of a quantum computation.

2. The quantum computer of claim 1, wherein said spin-transparent storage ring comprises:
said spin-transparent storage ring having a ring configuration with degenerate spin dynamics whereby any initial spin orientation of said polarized particle bunches remains the same from turn to turn; and
a three-dimensional (3D) spin corrector in said ring, said spin corrector including a sequence of magnets inserted into said spin-transparent ring.

3. The quantum computer of claim 2 wherein each of said qubits comprise:
a total of 1 to 10¹⁰ particles; and
said particles are electrons, ions, or paramagnetic neutral atoms.

4. The polarized bunches of claim 3 comprising said polarized bunches stored in said spin-transparent ring form a scalable quantum system of qubits including 1 to 100,000 qubits.

5. The quantum computer of claim 1 comprising:
said polarized particles are polarized electrons;
a polarized photo-cathode to convert polarization-entangled photons to polarization-entangled electrons; and
said measurement unit is a Mott polarimeter.

6. The quantum computer of claim 1 comprising said polarized particles are ions or paramagnetic neutral atoms.

7. The quantum computer of claim 6, wherein said spin-initialization unit is selected from the group consisting of cavity, microwave device, laser, electromagnetic field generator, wave generator and combinations thereof.

8. The quantum computer of claim 1 comprising said qubit is maintained at an effective particle temperature of 10 K to 10,000 K.

9. A method for scalable quantum computing, comprising:
generating a plurality of spin-entangled polarized particle bunches for multi-logic computations;
injecting said spin-entangled polarized particle bunches into a spin-transparent storage ring to generate a qubit corresponding to each of said polarized particle bunches;
all particles in the bunch are generated in the same quantum spin state, said quantum spin state being a superposition of the spin eigenstates α|↑ [symbol] +b|↓ [symbol] ;
a gate unit in said spin-transparent storage ring for performing quantum computations, said gate unit including one or more one-qubit gates and two-qubit gates; and
a measurement unit for measuring the final quantum spin state of the qubits after completion of the quantum computation.

10. The method of claim 9 wherein the polarized particles are selected from the group consisting of electrons, ions, and paramagnetic neutral atoms.

11. The method of claim 9 comprising said stored bunches having a quantum coherence time of at least 3 hours.

12. The method of claim 9 comprising a storage capacity of 1 to 100,000 qubits in said ring with said qubits free of quantum effects of particle motion and inter-bunch interaction.

13. The method of claim 9 comprising said qubit has an effective temperature of 10 K to 10,000 K.

14. The method of claim 9 comprising:
the polarized particles are electrons produced by a circularly polarized photons from a photo-cathode; and
said photons are produced by a timed sequence of laser pulses.

15. The method of claim 14 comprising:
said one-qubit gate unit that is a sequence of pulsed magnets; and
said measurement unit is a Mott polarimeter.

16. The method of claim 9 comprising the final spin quantum state is measured to a fidelity of better than 0.99.

17. The method of claim 9 wherein measuring the final spin quantum state comprises:
measuring the final bunch polarization destructively; and
reinjecting said spin-transparent storage ring with a new set of qubits.

18. The method of claim 9 wherein measuring the final spin quantum state comprises:
measuring the final bunch polarization non-destructively; and
reusing the stored beam for subsequent qubit reinitialization and manipulation.

19. The method of claim 10 wherein initializing the spin state of polarized ion and neutral atom bunches comprises setting said ions and neutral atoms to the required spin state by applying electromagnetic fields and lasers.

20. The method of claim 9, comprising:
using a qubit with long coherence time as a quantum sensor; and
using a qubit with long coherence time as a part of quantum memory.
